(19) United States
(12) Patent Application Publication
(10) Pub. No.: US 2022/0090714 A1
(43) Pub. Date: Mar. 24, 2022

(54) FLEXIBLE TUBE SEAL

(71) Applicant: Trelleborg Sealing Solutions Germany GmbH, Stuttgart (DE)

(72) Inventor: Alan Coppini, Gharghur (MT)

(73) Assignee: Trelleborg Sealing Solutions Germany GmbH, Stuttgart (DE)

(21) Appl. No.: 17/447,775

(22) Filed: Sep. 15, 2021

Related U.S. Application Data
(60) Provisional application No. 63/080,163, filed on Sep. 18, 2020.

(51) Int. Cl. F16L 27/107

(52) U.S. Cl. CPC F16L 27/107

(57) ABSTRACT

A tube seal configured to fluidically seal and connect a first and second tube includes an elastomeric seal conduit having a conduit skeleton. The elastomeric seal conduit extends along a longitudinal axis having a first end opposite a second end and having a hollow portion configured to transport a fluid between the first and second tubes. The conduit skeleton may be temporarily or permanently connected to the elastomeric seal conduit and extends along the longitudinal axis generally between the first and second ends. The conduit skeleton has a first band disposed a distance from a second band where the bands are aligned about the longitudinal axis and where at least one rib extends between and connects the bands. The conduit skeleton may be made from a different material in comparison to the elastomeric seal conduit or may have a higher modulus of elasticity in comparison to the elastomeric seal conduit.

### CROSS-REFERENCE TO RELATED APPLICATIONS

This utility application claims priority to provisional application 63/080,163 filed Sep. 18, 2020, the entire contents of which are fully incorporated herein with this reference.

### DESCRIPTION

### Field of the Invention

The present invention generally relates to tube seals. More particularly, the present invention relates to a tube seal having an elastomeric seal conduit having a conduit skeleton at least partially disposed therein.

### Background of the Invention

There are a lack of sealing solutions for connecting two tubes together which can be easily assembled, withstand internal pressure and cope with misalignment, whether that misalignment be radial, axial and/or angular. Accordingly, there is a need for an improved tube seal. The present invention fulfills these needs and provides other related advantages.

### SUMMARY OF THE INVENTION

This non-provisional patent application claims priority to provisional application 63/080,163 filed Sep. 18, 2020, the entire contents of which are fully incorporated herein with this reference.

Referring now to the drawings of the '163 provisional application, and more particularly to FIGS. 1-3, there is shown an exemplary embodiment of a tube seal provided according to the present invention which generally includes a flexible tubular skeleton and an elastomer material coupled to the skeleton. As illustrated in FIG. 1, the tube seal may be installed between two tubes and at least partially fill a gap between the two tubes. When installed, sealing interfaces on an outer diameter of the tube seal, which may be formed in the elastomer material, engage the tubes to seal against the tubes. The sealing interfaces may be formed on opposite end sections of the tube seal, as will be described further herein. In some embodiments, one or more of the tubes has a groove formed therein in which a portion of the tube seal resides, which can act to limit axial movement of the tube seal in one direction. Dimensions of the tube seal, such as diameter, length, and thickness, can be chosen based on corresponding dimensions of the tubes so the tube seal suitably fits within the tubes.

Referring specifically now to FIG. 3, the skeleton of the tube seal is illustrated. As can be seen, the skeleton includes a series of rings that are connected to one another by ribs, which may extend generally in parallel to a longitudinal axis of the skeleton. Alternatively, or in addition, one or more of the ribs may extend in a non-parallel fashion, such as diagonally, relative to the longitudinal axis. By forming the skeleton as rings that are connected together by ribs, voids can be formed in a circumference of the skeleton that may be filled with the elastomer material to form the tube seal. In some embodiments, each ring is connected to an adjacent ring by at least two ribs, but it should be appreciated that each ring may be connected to an adjacent ring by one rib or more than two ribs, such as three ribs. The skeleton is flexible and may comprise one or more flexible materials, including but not limited to various polymers and/or metals. Exemplary materials that may be used to form the skeleton include but are not limited to: high strength elastomers; various polyamides, such as those sold under the tradenames PA6, PA66, and PA612, which may be reinforced by glass fibers; polyurethanes; ultra-high molecular weight polyethylene; acetal; polyphenylene sulfide (PPS), PEEK and PEI. In some embodiments, the ribs comprise the same material as the rings of the skeleton, but it should be appreciated that the ribs can comprise a material that is more flexible than a material of the rings to increase the flexibility of the tube seal.

The rings may include, for example, a pair of end rings that are each connected to a respective middle ring. Each middle ring is illustrated as being connected to a pair of adjacent rings and each of the end rings is illustrated as being connected to an adjacent middle ring, but it should be appreciated that the skeleton may include only two rings, which would both be end rings. While each middle ring is illustrated as connecting to an adjacent end ring and middle ring, it should be appreciated that the skeleton may have one or more middle rings that connect to two adjacent middle rings if, for example, the skeleton includes two end rings and three or more middle rings. It should thus be appreciated that the number of middle rings may be adjusted, as desired, to produce the skeleton with a desired length. In some embodiments, the end rings define an end ring length, in the axial direction, that is greater than a middle ring length of the middle rings. A diameter and thickness of the end rings and the middle rings, on the other hand, may be the same so the end rings and the middle rings only differ in axial length. However, it should be appreciated that the diameter of one or more of the rings can differ from the diameter of at least one other ring.

The voids of the skeleton may be generally defined between the rings in space that is not occupied by one or more ribs. There may be at least one void formed between two adjacent rings. The voids may each extend through the entire thickness of the skeleton so the voids extend to an inner radius of the skeleton, which is defined by an inner radius of each ring. In some embodiments, the skeleton may define a skeleton volume, which is a total volume of the skeleton, with the voids occupying between 10% and 50% of the skeleton volume, such as 20%, 25%, or 30%. It should be appreciated that the flexibility of the skeleton can be adjusted by controlling the volume occupied by the voids, as well as other characteristics of the skeleton such as the material, the thickness, etc.

Referring specifically to FIGS. 1 and 2, it is illustrated that the skeleton of FIG. 3 may be completely enveloped in the elastomer material of the tube seal. As described further herein, it is not necessary that the skeleton is completely enveloped by the elastomer material. To form the tube seal, the skeleton may be provided in a mold and enveloped in molten and/or uncured elastomer material so the elastomer material covers the skeleton and fills the voids. The molten and/or uncured elastomer material may be allowed to solidify in and around the skeleton, either by cooling or through cross-linkage reactions. The elastomer material is more flexible than material of the skeleton so the skeleton acts as a support structure within the elastomer material. Further, the elastomer material fills the voids in the skeleton to form a solid bond between the elastomer material and the skeleton, reducing the risk that the elastomer material separates from the skeleton. The elastomer material may include, for example, various polymers. Exemplary polymers include, but are not limited to: EPDM rubber; FKM fluoroelastomers; liquid silicone rubber (LSR); polyurethanes; nitrile rubber (NBR); and/or thermoplastic elastomer (TPE). It should be appreciated that the previously described materials are exemplary only, and the elastomer material may comprise any material that is more flexible than the material of the skeleton and can form a fluid seal. The mold may have one or more grooves formed therein so the elastomer material has the sealing interfaces formed therein once the elastomer material solidifies. In some embodiments, the sealing interfaces, illustrated as projections on an outer surface of the elastomer material, are radially aligned with the end rings so the sealing interfaces are radially supported by the end rings.

Referring now to FIGS. 4-5, another exemplary embodiment of a tube seal provided according to the present invention is illustrated. The tube seal of FIGS. 4-5 includes a skeleton and an elastomer material, similar to the previously described tube seal, but sealing interfaces of the tube seal, which may be formed in the elastomer material, are formed on an inner diameter of the tube seal, rather than the outer diameter. By forming the sealing interfaces on the inner diameter, the tube seal may be disposed so that the tube seal partially surrounds two tubes, rather than vice-versa as illustrated in FIG. 1. In such an embodiment, end rings of the skeleton, which are radially aligned with the sealing interfaces, may be exposed to reduce the amount of elastomer material that is used to form the tube seal. In other respects, the tube seal of FIGS. 4-5 may be similar to the tube seal of FIGS. 1-3.

FIGS. 4-5 illustrate the flexing behavior of the tube seal. It should be appreciated that the flexing behavior of the tube seal illustrated in FIGS. 1-3 can be similar to the tube seal of FIGS. 4-5 or the tube seals of FIGS. 6-9, which are described further herein. As illustrated, the tube seal is able to flex when the tubes coupled to the tube seal come out of coaxial alignment and/or angular misalignment. The tube seal is able to flex due to the flexibility of the elastomer material and the supporting skeleton, which is more rigid than the elastomer material but still able to flex due to the presence of the voids. This flexibility of the tube seal keeps the sealing interfaces in contact with the tubes to maintain the seal even when the tubes come out of coaxial alignment or angular alignment.

Referring now to FIGS. 6-7, another exemplary embodiment of a tube seal provided according to the present invention is illustrated that includes a skeleton partially enveloped by an elastomer material. The tube seal of FIGS. 6-7 is configured for sealing on an outer diameter of the elastomer material by having sealing interfaces formed on the outer diameter of the elastomer material that are radially aligned with end rings of the skeleton, similar to the tube seal of FIGS. 1-3. Unlike the tube seal of FIGS. 1-3, the tube seal of FIGS. 6-7 has a skeleton that is only partially enveloped by the elastomer material so a portion of the skeleton is exposed. As best illustrated in FIG. 7, portions of one or more rings, such as end rings, of the skeleton may be exposed, i.e., not enveloped in the elastomer material, to make it easier to grip the rings during manufacturing. The exposed portions of the end rings may be on an inner diameter of the end rings, opposite the outer diameter where the sealing interfaces are located. It should thus be appreciated that the exposed portion(s) of the skeleton may alternatively be on an outer diameter of one or more rings if the tube seal is configured for inner diameter sealing and has sealing interfaces on an inner diameter of the elastomer material.

Referring now to FIGS. 8-9, another exemplary embodiment of a tube seal provided according to the present invention is illustrated that has a skeleton partially enveloped by an elastomer material. As illustrated in FIGS. 8-9, the skeleton has end rings with exposed axial faces that are not enveloped by the elastomer material, which may assist with handling of the tube seal during manufacturing. The elastomer material may also have grooves formed therein that are adjacent to and surround the end rings, which may also assist with handling of the tube seal during manufacturing. In other respects, the tube seal of FIGS. 8-9 may be similar to the previously described tube seals of FIGS. 1-3 and 6-7.

Referring now to FIG. 10, exemplary shapes for sealing interfaces, which may also be referred to as “beads,” that may be formed in the elastomer material of the tube seal provided according to the present invention are illustrated. It should be appreciated that the shapes illustrated in FIG. 10 are exemplary shapes only and the sealing interfaces provided according to the present invention may have any shape that is suitable for forming a fluid seal when properly engaged with a surface. In some embodiments, each sealing interface formed in the elastomer material has a similar shape to the other sealing interface(s) formed in the elastomer material. However, it should be appreciated that the elastomer material may be formed with at least one first sealing interface having a first shape and at least one second sealing interface having a second shape that differs from the first shape. Thus, many different configurations of the elastomer material may be provided according to the present invention to account for different sealing environments and/or sealing behavior of the tube seal.

By enveloping some or all of the relatively rigid skeleton within the relatively flexible elastomer material, the tube seal provided according to the present invention, when installed, can seal against the tubes while still being able to flex in response to relative movement between the tubes. The voids in the skeleton allow the skeleton to be flexible, despite being a more rigid material than the elastomer material, and filling the voids of the skeleton with the elastomer material reduces the risk of the elastomer material separating from the skeleton. Forming the sealing interfaces to be radially aligned with the end rings of the skeleton also can reduce the risk of the sealing interfaces collapsing radially inward during flexing of the tube seal, maintaining the integrity of the sealing interface. Thus, the tube seal provided according to the present invention can maintain a stable fluid seal between the tube seal and the tubes during flexing responsive to misalignment of the tubes relative to one another.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

### BRIEF DESCRIPTION OF THE DRAWINGS

The accompanying drawings illustrate the invention. In such drawings:

FIG. 1 is an isometric view of one embodiment of a tube seal of the present invention;

FIG. 2 is an isometric view of the structure of FIG. 1 where the elastomeric seal conduit has been removed to show the conduit skeleton disposed within;

FIG. 3 is a sectional view taken along lines 3-3 of FIG. 1;

FIG. 4 is a side view showing the cross section of FIG. 3;

FIG. 5 is an isometric view of another embodiment of a tube seal of the present invention;

FIG. 6 is an isometric view of the structure of FIG. 5 where the elastomeric seal conduit has been removed to show the conduit skeleton disposed within;

FIG. 7 is a sectional view taken along lines 7-7 of FIG. 5;

FIG. 8 is a side view showing the cross section of FIG. 7;

FIG. 9 is an isometric view of another embodiment of a tube seal of the present invention;

FIG. 10 is an isometric view of the structure of FIG. 9 where the elastomeric seal conduit has been removed to show the conduit skeleton disposed within;

FIG. 11 is a sectional view taken along lines 11-11 of FIG. 1;

FIG. 12 is a side view showing the cross section of FIG. 12;

FIG. 13 is an isometric view of another embodiment of a tube seal of the present invention;

FIG. 14 is an isometric view of the structure of FIG. 13 where the elastomeric seal conduit has been removed to show the conduit skeleton disposed within;

FIG. 15 is a sectional view taken along lines 15-15 of FIG. 13;

FIG. 16 is a side view showing the cross section of FIG. 15;

FIG. 17 is an enlarged sectional view of one embodiment of a sealing interface;

FIG. 18 is an enlarged sectional view of another embodiment of a sealing interface;

FIG. 19 is an enlarged sectional view of another embodiment of a sealing interface;

FIG. 20 is an enlarged sectional view of another embodiment of a sealing interface;

FIG. 21 is an enlarged sectional view of another embodiment of a sealing interface;

FIG. 22 is an enlarged sectional view of another embodiment of a sealing interface; and

FIG. 23 is a sectional view of another embodiment of the present invention showing a male-to-female tube seal having differing diameters.

### DETAILED DESCRIPTION OF THE PREFERRED EMBODIMENTS

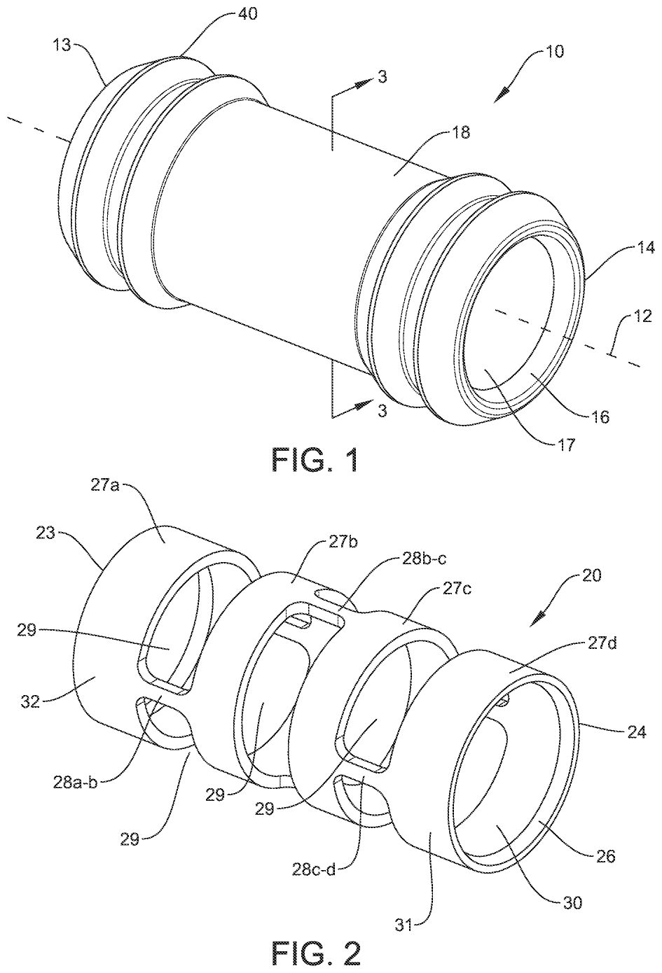

Referring now to this application, FIGS. 1-4 illustrate one embodiment of a tube seal 10 of the present invention. The tube seal 10 is configured to fluidically seal and fluidically connect a first tube and a second tube, which are not shown but understood by those skilled in the art. For example, the first and second tubes may or may not have a gap disposed between them. The tube seal 10 of the present invention is designed to fit within or around the first and second tubes to fill this gap. Furthermore, the first and second tubes may not be aligned with respect to one another. Accordingly, the tube seal 10 of the present invention is configured to compensate for such misalignments while still fluidically sealing and fluidically connecting the first and second tubes.

An elastomeric seal conduit 11 is defined as extending along a longitudinal axis 12 having a first end 13 opposite a second end 14. The elastomeric seal conduit 11 defines a hollow portion 15 extending between the first and second ends configured to transport a fluid between the first and second tubes. The elastomeric seal conduit has an inner surface 17 and an outer surface 18.

As best shown in FIG. 2, a conduit skeleton 20 is connected to the elastomeric seal conduit. The conduit skeleton also extends along the longitudinal axis between the first and second ends of the elastomeric seal conduit. However, the conduit skeleton may extend to the same ends as the elastomeric seal conduit, or alternatively, may stop short of the ends 13, 14 or may be extend past the ends 13, 14. Thus, the conduit skeleton has its own first end 23 and a second end 24.

The conduit skeleton has a first band 27a disposed a distance from a second band 27d wherein the first and second bands are aligned about the longitudinal axis. FIG. 2 actually shows four bands 27a, 27b, 27c, 27d, but is understood that just two bands could be used in accordance with the teaching of this application. Likewise, any number of bands may be used from 2 to any “n” number of bands, such as 3, 4, 5, 6, 7 . . . etc.

Each band has at least one rib 28 extending between and connecting adjacent bands. As shown in FIG. 2, a pair of oppositely disposed ribs 28a-b connect band 27a to band 27b. Similarly, pair of ribs 28b-c connect band 27b to 27c. Similarly, a pair of ribs 28c-d connect band 27c to 27d. It will be understood that just one rib (not two ribs) may be used in accordance with the present invention. Whether using one or two ribs, the adjacent bands are able to flex about the rib. Thus, the rib acts as a flexure allowing the bands to pivot about the flexural rib. This allows the overall tube seal 10 assembly to flex and move while still retaining its shape due to the bands.

Referring again to FIG. 2, it is noted that the first pair of ribs 28a-b oppositely disposed about the longitudinal axis 12 extending between and connecting the band 27 and band 27b are rotated 90 degrees about the longitudinal axis 12 in comparison to the second pair of ribs 28b-c. Likewise, the third pair of ribs 28c-d are rotated 90 degrees about the longitudinal axis in comparison to the second pair of ribs 28b-c. By rotating the adjacent ribs, this then allows a pivoting about both an X-axis and a Y-axis if one was to define the longitudinal axis as the Z-axis. Alternatively, in an embodiment now shown, the adjacent pair of ribs may not be rotated but positioned similarly such that just one axis of rotation in created. Alternatively again, in an embodiment not shown, the adjacent ribs may be rotated something less than 90 degrees. This could then be used to create a flexible tube seal that was only flexible about a smaller range of axes for specific applications.

As shown in FIG. 1, the elastomeric seal conduit may optionally have a chamfer 16 such that it aids in fluid flowing there through. Similarly, as best shown in FIG. 2, the conduit skeleton may have a similarly shaped chamfer 16.

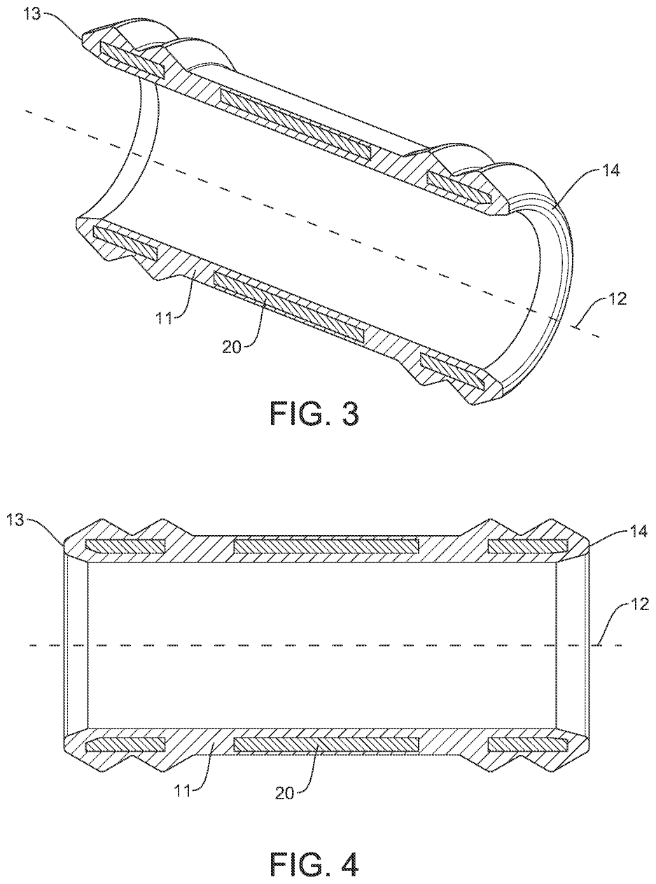

The conduit skeleton 20 may be attached to the elastomeric seal conduit in a variety of methods. For example, as best shown in FIGS. 3-4, the conduit skeleton may first be formed and then overmolded with the elastomeric seal conduit. This then creates a permanent connection between the elastomeric seal conduit and the conduit skeleton. In other alternatives, a portion of the conduit skeleton may be exposed which is not overmolded.

In yet another alternative, the elastomeric seal conduit and conduit skeleton may be separately manufactured and then combined afterwards. In such an embodiment the elastomeric seal conduit would have portions shaped within that would then match the shape of the conduit skeleton such that the two parts would lock into place in relation to one another when assembled together. Alternatively, adhesives or glues could be used to make the assembly a permanent assembly. Furthermore, the conduit skeleton could be disposed on either the outside of or the inside of the elastomeric seal conduit.

The conduit skeleton could be made from a different material in comparison to the elastomeric seal conduit. Said differently, the conduit skeleton could have a higher modulus of elasticity in comparison to the elastomeric seal conduit. Thus, the conduit skeleton would be stiffer in comparison to the elastomeric seal conduit, yet still be able to flex about the ribs 28 due to their reduced material volumes.

Accordingly, the conduit skeleton may comprise a high strength elastomer, a polyamide, a polyamide reinforced by glass fibers, a polyurethane, an ultra-high molecular weight polyethylene, acetal, polyphenylene sulfide (PPS), PEEK and/or PEI. Furthermore, the conduit skeleton may comprise metals, whether they be machined or 3D printed such as SLS (Selective Laser Sintering) materials. Furthermore, the conduit skeleton may comprise composite materials such as carbon fiber or glass fiber reinforced plastics such as Orkot®.

The elastomeric seal conduit may comprise an EPDM rubber, a FKM fluoroelastomer, a liquid silicone rubber (LSR), a polyurethane, a nitrile rubber (NBR), a thermoplastic elastomer (TPE) and/or a room temperature vulcanization (RTV) rubber.

When referring to FIG. 2, it will be appreciated that the ribs 28 are integrally formed at the same time of the bands 27 such that one material choice is consistent throughout the conduit skeleton. However, in a different embodiment the at least one rib may formed from a different material as the bands. Thus, the at least one rib may have a lower modulus of elasticity in comparison to the bands.

In all the embodiments shown herein, the tube seal 10 of the present invention is cylindrical in overall shape, meaning the tube seal has a circular cross-section along the longitudinal axis. It will be appreciated by those skilled in the art that other non-circular shapes could be made while being consistent with this teaching. For example, a tube seal could be made that was square or rectangular such that it would be fitted to similar shaped square and rectangular tubes that needed attachment. Likewise, other shapes could be devised beyond circles, such as triangles, pentagons, hexagon, octagons and the like.

Referring again to FIG. 2, to be clear regarding the shape of the conduit skeleton, a material void volume 29 of conduit skeleton is between the bands and gaps. The material void volume 29 is delimited by an inner surface 30 and outer surface 31 of the conduit skeleton. These material void volumes are then filled by the elastomeric seal conduits as best shown in FIGS. 3 and 4 during the overmold process. Thus, a skeleton envelope volume 32 is delimited by the inner surface 30 and the outer surface 31 of the conduit skeleton extending between its ends 23 and 24. Now it can be stated that the total material void volume 29 is from 10% up to 50% of the skeleton envelope volume 32. In other embodiments, for increased flexibility the total material void volume may be higher than 50%, such that the total material void volume may range from 10% all the way up to 90%.

As shown herein, for the majority of the elastomeric seal conduit it has the same thickness 19. However, it is understood that this thickness may vary along its length. For example, the thickness may be stepped or sloped when moving along the longitudinal axis. This could then facilitate different stiffnesses at different points along the tube seal for specific applications. Likewise, a thickness 39 of the conduit skeleton may be the same or may be different. For example, the thickness 39 of a first band may not be the same as a thickness of the second band. Again, this could facilitate different stiffnesses at different points along the tube seal for specific applications.

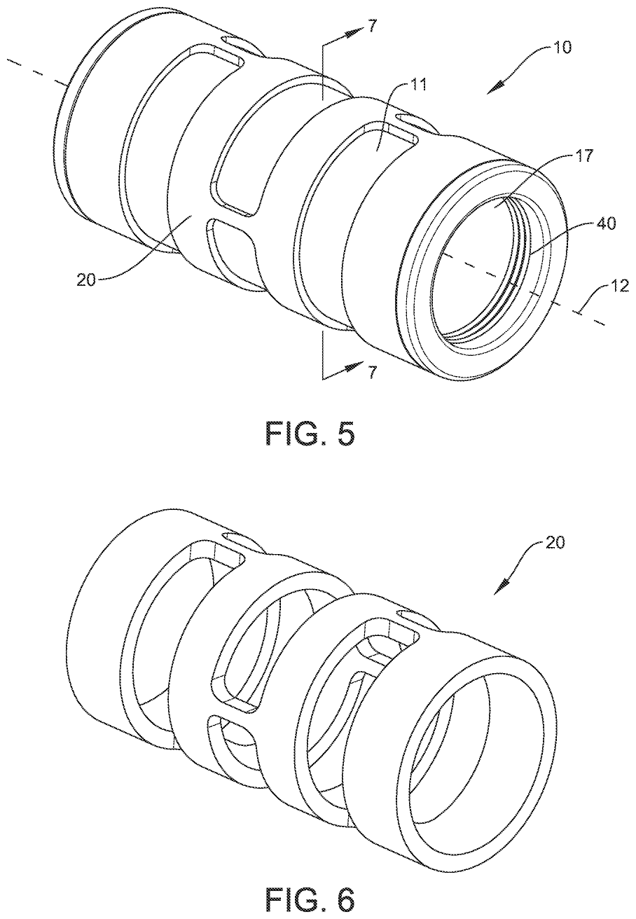

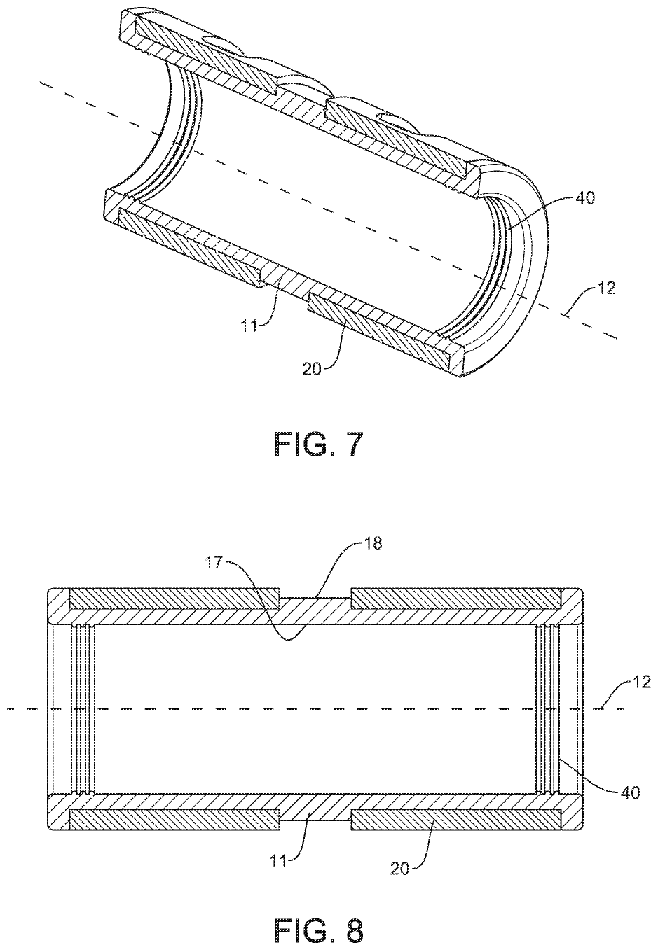

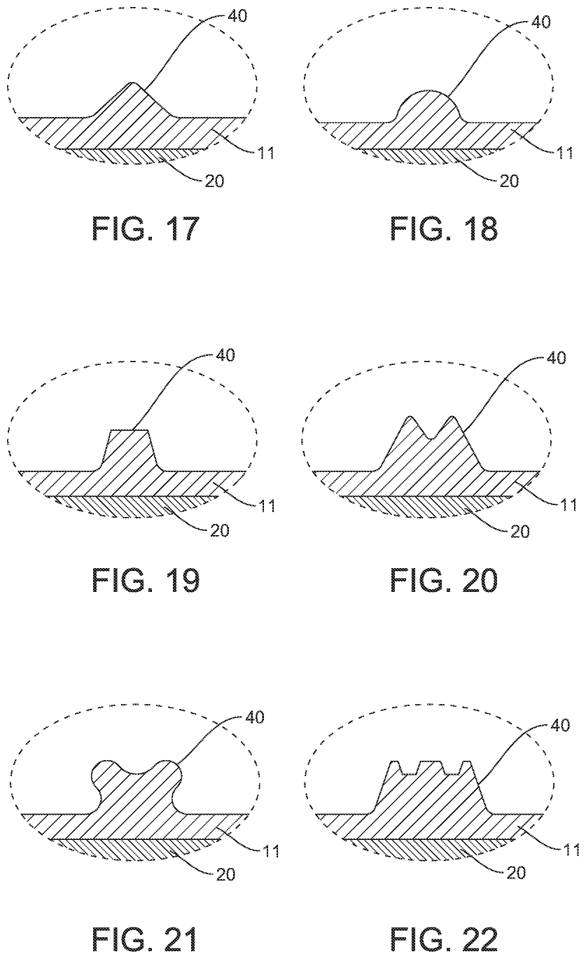

Referring back to FIG. 1 and also shown in FIGS. 3 and 4, the elastomeric seal conduit has at least one annularly disposed sealing interface 40 integrally formed in the elastomeric seal conduit about the longitudinal axis. FIGS. 17-22 show different embodiments of the sealing interface 40. It is understood by those skilled in the art that the at least one annularly disposed sealing interface may be formed on an outside surface of the elastomeric seal conduit or on an inside surface of the elastomeric seal conduit as best shown in FIGS. 5-8.

It is understood that the at least one annularly disposed sealing interface may comprise at least one bead 40 that is configured to fluidically seal to the first or second tubes. Said differently, a cross-section through the bead 40 aligned along the longitudinal axis has a bead shape with at least one raised feature in comparison to its respective inner or outer surface of the elastomeric seal conduit. Due to the bead 40 being raised, it is forced into abutment with the tubes it is sealing. In this manner a good seal is formed to fluidically seal and fluidically connect the first and second tubes.

FIGS. 5-8 show another embodiment of the tube seal of the present invention. Like numerals are used throughout the embodiments such that not all the numerals are repeated in the drawings for simplicity. In this embodiment, the conduit skeleton is at least partially disposed outside of the elastomeric seal conduit, where it may be temporarily or permanently attached with an adhesive/bond and/or overmolding process. The sealing interface 40 is not disposed on the inner surface 17 of the elastomeric seal conduit.

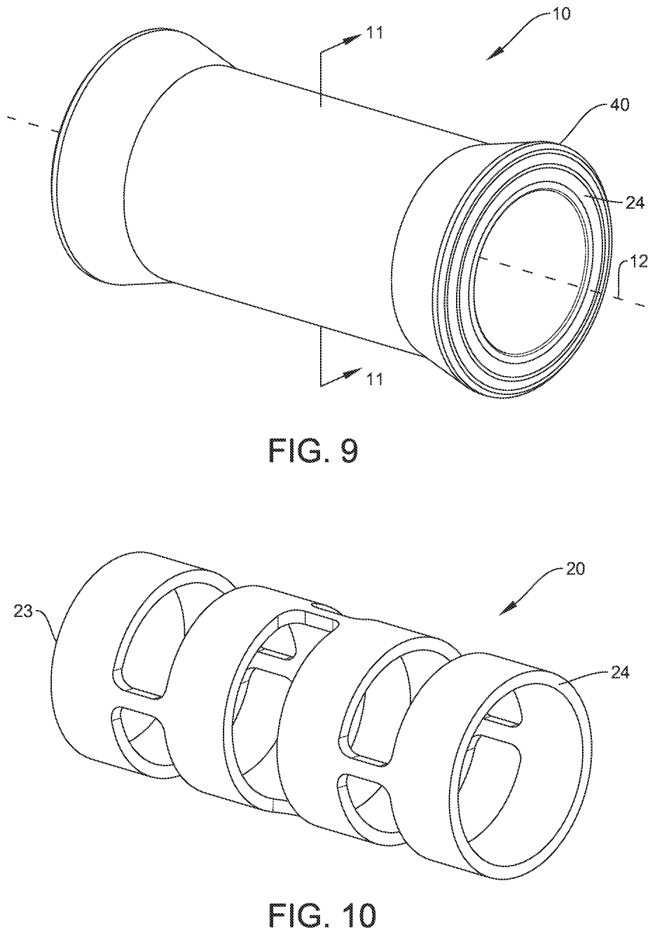

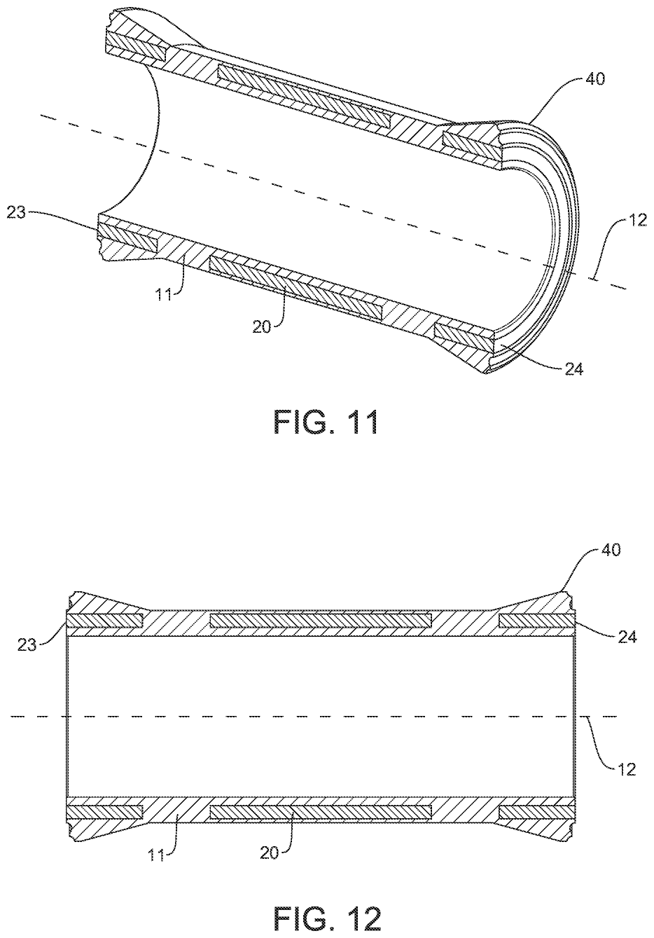

FIGS. 9-12 show another embodiment of the tube seal of the present invention. Here, the conduit skeleton has at least one band having an exposed axial face 23, 24 that is not enveloped by the elastomeric seal conduit.

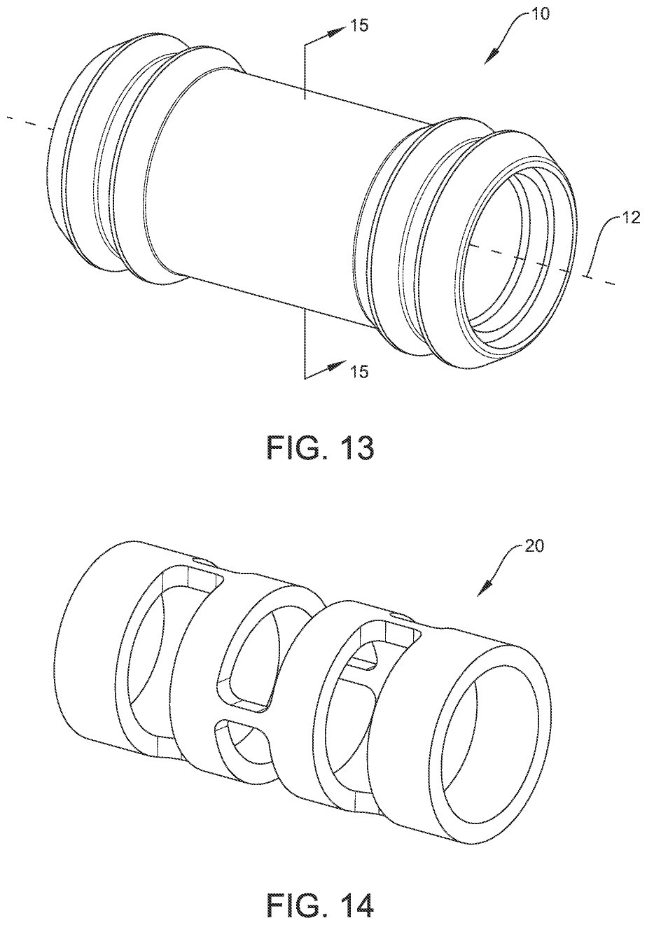

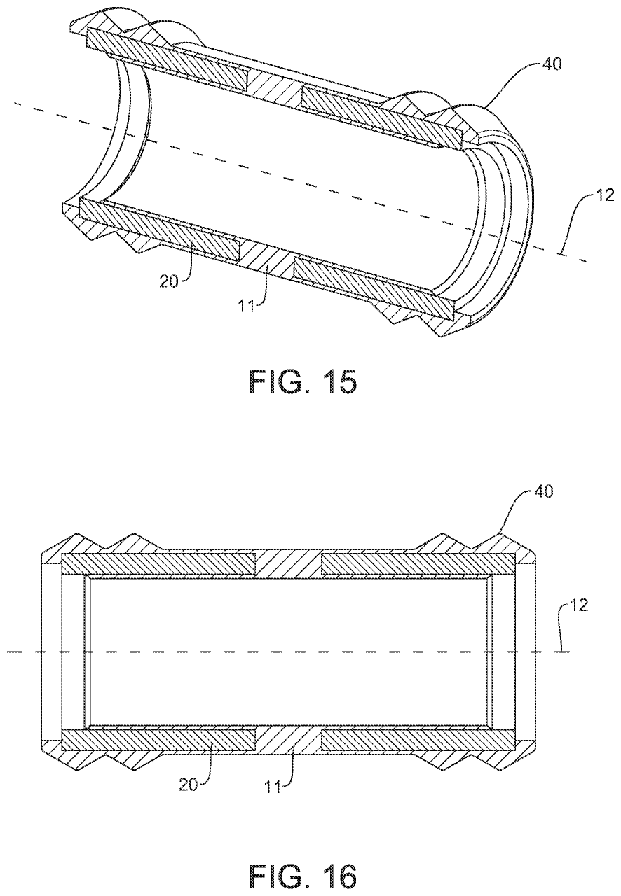

FIGS. 13-16 show another embodiment of the tube seal of the present invention. Here, the conduit skeleton has at least one portion being exposed inside the tube seal 10. As previously discussed, these exposed surfaces of the conduit skeleton may be used during the manufacturing process for holding and fixturing.

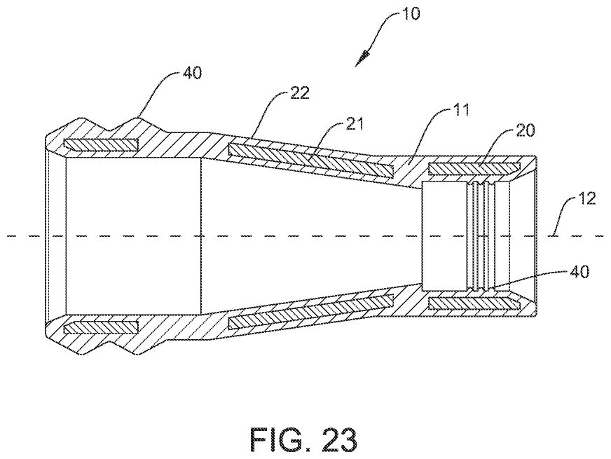

For simplicity, this teaching in FIGS. 1-16 showed tube seals that were sealing two tubes of the same diameters. However, it is understood by those skilled in the art that the tube seal of the present invention could be used to connect two tubes of differing diameters, whether the tube seal of the present was attached inside or outside the two tubes. This embodiment is best shown in FIG. 23. For example, a conical section could combine two halves such that a reduction in diameter could be obtained. For example, the conduit skeleton has a conical portion 21 that matches the conical portion 22 of the elastomeric seal conduit.

Furthermore, it is understood that this teaching in FIGS. 1-16 taught both male-to-male and female-to-female tube seal versions, where the tube seal of the present invention was designed to be placed within two similar tubes or outside two similar tubes. Therefore, it will also be understood by those skilled in the art that a male-to-female or female-to-male tube seal could also be devised based on the teachings disclosed herein as best shown again in FIG. 23. For example, the left half of the embodiment shown in FIG. 23 is a male portion that then transitions into the right half portion that is a female portion. This would then create a tube seal that is disposed inside one tube while disposed outside another tube. Furthermore, a male-to-female tube seal (i.e. a female-to-male tube seal when simply flipped around) could also be used to connect two tubes of differing diameters as shown in FIG. 23. It is understood that the teachings in FIG. 23 can be applied to any of the other embodiments shown and taught herein.

In its broadest interpretation, the term “conduit” means a structure by which something is transmitted. Typically, this means a pipe or channel for conveying fluids, such as water, or a tube or duct for enclosing electric wires or cable. Conduits for conveying a fluid (liquid and/or gas) are typically cylindrical (round) in cross section but could be square, rectangular, triangular, or have 5, 6, 7, 8 or any number of sides. Thus, it will be appreciated by those skilled in the art that the present invention disclosed herein could utilize any of the cross-sectional shapes mentioned herein while retaining the novel aspects of the present invention.

Likewise, the use of the word “tube” in its broadest interpretation means a structure by which something is transmitted. Tubes are typically thought of as having a cylindrical cross-section, but could have any of the other non-circular cross-sectional shapes discussed herein.

The use of the word “band” in its broadest interpretation means a structure that extends around the longitudinal axis. The band is typically circular in shape (i.e. a ring shape), but could have any of the other non-circular cross-sectional shapes discussed herein such that it matched the shape of the conduits/tubes.

It is understood by those skilled in the art that a fluid can be a liquid, a gas or a combination thereof.

Although several embodiments have been described in detail for purposes of illustration, various modifications may be made to each without departing from the scope and spirit of the invention. Accordingly, the invention is not to be limited, except as by the appended claims.

### REFERENCE NUMERALS

10 tube seal

11 elastomeric seal conduit

12 longitudinal axis

13 first end, elastomeric seal conduit

14 second end, elastomeric seal conduit

15 hollow portion

16 chamfer, elastomeric seal conduit

17 inner surface, elastomeric seal conduit

18 outer surface, elastomeric seal conduit

19 thickness, elastomeric seal conduit

20 conduit skeleton

21 conical portion, conduit skeleton

22 conical portion, elastomeric seal conduit

23 first end, conduit skeleton

24 second end, conduit skeleton

26 chamfer, conduit skeleton

27 band, conduit skeleton

28 rib, conduit skeleton

29 material void volume, conduit skeleton

30 inner surface, conduit skeleton

31 outer surface, conduit skeleton

32 skeleton envelope volume

39 thickness, conduit skeleton

40 sealing interface, elastomeric seal conduit

What is claimed is:

1. A tube seal configured to fluidically seal and fluidically connect a first tube and a second tube, the tube seal comprising:
an elastomeric seal conduit defined as extending along a longitudinal axis having a first end opposite a second end, wherein the elastomeric seal conduit defines a hollow portion extending between the first and second ends configured to transport a fluid between the first and second tubes; and
a conduit skeleton connected to the elastomeric seal conduit and extending along the longitudinal axis between the first and second ends;
wherein the conduit skeleton has a first band disposed a distance from a second band, wherein the first and second bands are aligned about the longitudinal axis, and wherein at least one rib extends between and connects the first and second bands.

2. The tube seal of claim 1, wherein the conduit skeleton is made from a different material in comparison to the elastomeric seal conduit.

3. The tube seal of claim 1, wherein the conduit skeleton has a higher modulus of elasticity in comparison to the elastomeric seal conduit.

4. The tube seal of claim 1, wherein the at least one rib is formed from a different material as the first and second bands.

5. The tube seal of claim 1, wherein the at least one rib has a lower modulus of elasticity in comparison to the first and second bands.

6. The tube seal of claim 1, wherein the conduit skeleton is integrally formed having the same material for the first and second bands and the at least one rib.

7. The tube seal of claim 1, wherein the tube seal is circular in cross-section along the longitudinal axis.

8. The tube seal of claim 1, wherein a material void volume of conduit skeleton is defined as between the first and second bands and the at least one gap, wherein the material void volume is delimited by an inner surface and outer surface of the conduit skeleton.

9. The tube seal of claim 8, wherein the material void volume of the conduit skeleton is filled by the elastomeric seal conduit.

10. The tube seal of claim 9, wherein a skeleton envelope volume is delimited by the inner surface and the outer surface of the conduit skeleton extending between its ends.

11. The tube seal of claim 10, wherein the material void volume is from 10% up to 50% of the skeleton envelope volume.

12. The tube seal of claim 1, wherein the conduit skeleton comprises a high strength elastomer, a polyamide, a polyamide reinforced by glass fibers, a polyurethane, an ultra-high molecular weight polyethylene, an acetal, a polyphenylene sulfide (PPS), a PEEK, a PEI, a metal, a composite, a carbon fiber and/or a glass reinforced plastic.

13. The tube seal of claim 1, wherein the elastomeric seal conduit comprises an EPDM rubber, a FKM fluoroelastomer, a liquid silicone rubber (LSR), a polyurethane, a nitrile rubber (NBR), a thermoplastic elastomer (TPE) and/or a room temperature vulcanization (RTV) rubber.

14. The tube seal of claim 1, wherein the conduit skeleton is completely enveloped in the elastomeric seal conduit.

15. The tube seal of claim 1, wherein the conduit skeleton is partially enveloped in the elastomeric seal conduit and partially exposed from the elastomeric seal conduit.

16. The tube seal of claim 1, wherein the conduit skeleton has at least one band having an exposed axial face that is not enveloped by the elastomeric seal conduit.

17. The tube seal of claim 1, including at least one annularly disposed sealing interface integrally formed in the elastomeric seal conduit about the longitudinal axis.

18. The tube seal of claim 17, wherein the at least one annularly disposed sealing interface is formed on an outside surface of the elastomeric seal conduit or on an inside surface of the elastomeric seal conduit.

19. The tube seal of claim 18, wherein the at least one annularly disposed sealing interface comprises at least one bead that is configured to fluidically seal to the first or second tubes.

20. The tube seal of claim 19, wherein a cross-section through the at least one bead aligned along the longitudinal axis has a bead shape with at least one raised feature in comparison to its respective inner or outer surface of the elastomeric seal conduit.

21. The tube seal of claim 1, wherein the conduit skeleton includes at least one middle rib disposed between the first and seconds bands, wherein the at least one rib comprises a first pair of ribs oppositely disposed about the longitudinal axis extending between and connecting the first and middle bands, and including a second pair of ribs oppositely disposed about the longitudinal axis extending between and connecting the middle and second bands, wherein the first pair of bands are rotated 90 degrees about the longitudinal axis in comparison to the second pair of ribs.

22. The tube seal of claim 1, wherein the conduit skeleton includes at least two middle bands disposed between the first and seconds bands, wherein each band has a respective at least one rib connecting it to an adjacent band.

23. The tube seal of claim 1, wherein a thickness of the first band is not the same as a thickness of the second band.

24. The tube seal of claim 1, wherein the at least one rib comprises at least two ribs oppositely disposed about the longitudinal axis.

25. The tube seal of claim 1, wherein the conduit skeleton is permanently attached to the elastomeric seal conduit.

26. A tube seal configured to fluidically seal and fluidically connect a first tube and a second tube, the tube seal comprising:
an elastomeric seal conduit defined as extending along a longitudinal axis having a first end opposite a second end, wherein the elastomeric seal conduit defines a hollow portion extending between the first and second ends configured to transport a fluid between the first and second tubes; and
at least one annularly disposed sealing interface integrally formed in the elastomeric seal conduit about the longitudinal axis;
wherein the at least one annularly disposed sealing interface is formed on an outside surface of the elastomeric seal conduit or on an inside surface of the elastomeric seal conduit;
wherein the at least one annularly disposed sealing interface comprises at least one bead that is configured to fluidically seal to the first or second tubes;
wherein a cross-section through the bead aligned along the longitudinal axis has a bead shape with at least one raised feature in comparison to its respective inner or outer surface of the elastomeric seal conduit; and
a conduit skeleton connected to the elastomeric seal conduit and extending along the longitudinal axis between the first and second ends;
wherein the conduit skeleton has a first band disposed a distance from a second band, wherein the first and second bands are aligned about the longitudinal axis, and wherein a first pair of ribs are oppositely disposed about the longitudinal axis extending between and connecting the first and second bands;
wherein the conduit skeleton is made from a different material in comparison to the elastomeric seal conduit; and
wherein the conduit skeleton has a higher modulus of elasticity in comparison to the elastomeric seal conduit.

27. A tube seal configured to fluidically seal and fluidically connect a first tube and a second tube, the tube seal comprising:
an elastomeric seal conduit defined as extending along a longitudinal axis having a first end opposite a second end, wherein the elastomeric seal conduit defines a hollow portion extending between the first and second ends configured to transport a fluid between the first and second tubes; and
a conduit skeleton connected to the elastomeric seal conduit and extending along the longitudinal axis between the first and second ends;
wherein the conduit skeleton has a first band disposed a distance from a middle band which in turn is disposed a distance from a second band, wherein the first, middle and second bands are aligned about the longitudinal axis;
wherein the conduit skeleton includes a first pair of ribs oppositely disposed about the longitudinal axis extending between and connecting the first and middle bands;
wherein the conduit skeleton includes a second pair of ribs oppositely disposed about the longitudinal axis extending between and connecting the middle and second bands;
wherein the first pair of ribs are rotated 90 degrees about the longitudinal axis in comparison to the second pair of ribs;
wherein the conduit skeleton is made from a different material in comparison to the elastomeric seal conduit; and
wherein the conduit skeleton has a higher modulus of elasticity in comparison to the elastomeric seal conduit.
